(19) United States
(12) Patent Application Publication
(10) Pub. No.: US 2023/0113408 A1
(43) Pub. Date: Apr. 13, 2023

(54) TRAINING AND INFERENCE MANAGEMENT FOR COMPOSITE MACHINE LEARNING SCENARIOS

(71) Applicant: SAP SE, Walldorf (DE)

(72) Inventor: Manikandan RAJASEKAR, Wiesloch (DE)

(21) Appl. No.: 17/499,271

(22) Filed: Oct. 12, 2021

(51) Int. Cl. G06N 20/00; G06K 9/62

(52) U.S. Cl. CPC G06N 20/00; G06K 9/6227; G06K 9/6256

(57) ABSTRACT

Systems and methods include reception of a request to train a composite machine learning scenario comprising a plurality of machine learning scenarios, in response to the request, identification of a training dataset associated with each of the plurality of machine learning scenarios and triggering of training of each of the plurality of machine learning scenarios based on an associated training dataset to generate a plurality of trained machine learning models, acquisition of metrics associated with each trained machine learning model, aggregation of the acquired metrics into training metrics associated with the composite machine learning scenario, and return of the training metrics associated with the composite machine learning scenario.

### BACKGROUND

Modern database systems store vast amounts of data for their respective enterprises. Applications and other logic may access this stored data in order to perform various functions. Functions may include estimation or forecasting of data values based on stored data. Such estimation, forecasting and other functions are increasingly provided by trained neural networks, or models.

A model may be trained to infer a value of a target (e.g., a delivery date) based on a set of inputs (e.g., fields of a sales order). The training may be based on historical data (e.g., a large number of sales orders and their respective delivery dates) and results in a trained model which represents patterns in the historical data. The trained model may be user to infer a target value for which it was trained (e.g., a delivery date) based on new input data (e.g., fields of a new sales order).

Applications may consume increasing numbers of trained models in order to improve their functionality. For example, different sets of fields of a same record may be inferred by different respective trained models. These models may be trained across different machine learning technologies, algorithms, and platforms.

Currently, applications are responsible for training models, requesting inferences from trained models, and consuming the returned inferences. Such applications already require complex periodic maintenance such as patches, updates, upgrades, and change management processes. Supporting machine learning model training and consumption adds significantly to this effort. For example, any changes in the interface contract or in related attributes and properties will usually require revision of the application logic.

Moreover, for processes which employ multiple trained models, an application administrator must ensure that all of the multiple trained models trained on up-to-date data, and that usage thereof conforms to any dependencies and protocols such as reuse, sequence, order, parallel processing, etc. The consistency between the datasets used to train each model may significantly impact the correctness and accuracy of resulting inferences.

Different models trained and executed on different platforms will likely produce inferences having different structures and semantics. Aggregation and consumption of such inferences by an application requires high development and maintenance costs as well as high operational costs.

Systems are desired to address one or more deficiencies in conventional model training, usage and lifecycle management.

### BRIEF DESCRIPTION OF THE DRAWINGS

FIG. 1 is a block diagram of relationships between an application and multiple machine learning scenarios according to some embodiments.

FIG. 2 is a block diagram of an architecture to train and consume composite machine learning scenarios according to some embodiments.

FIG. 3 is a sequence diagram of training a composite machine learning scenario according to some embodiments.

FIG. 4 illustrates pushing of training data to machine learning platforms/services according to some embodiments.

FIG. 5 illustrates pushing of training data to machine learning platforms/services according to some embodiments.

FIG. 6 is a sequence diagram of consuming an inference result of a composite machine learning scenario according to some embodiments.

FIG. 7 is a sequence diagram of consuming an application-triggered inference result of a composite machine learning scenario according to some embodiments.

FIG. 8 is a block diagram of a composite scenario lifecycle manager according to some embodiments.

FIG. 9 is an entity relationship diagram of a composite scenario object according to some embodiments.

FIG. 10 is a block diagram of a hardware system to manage composite machine learning scenarios according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Briefly, some embodiments efficiently facilitate usage of multiple machine learning models by an application. Embodiments may efficiently manage training of multiple machine learning models used to generate a composite inference, as well as aggregation of the individual inferences of the multiple models into a composite inference encapsulated by a single object. Changes to the machine learning models, or to their training data, training platforms, training algorithms, and output structures and protocols may be addressed without requiring code changes to the application.

As used herein, a machine learning (ML) scenario is a pipeline designed to solve a specific ML problem. An ML scenario defines training data, any required pre-processing, model hyperparameters, ML algorithms (e.g., Python code) for a given ML platform and service which are used to process the training data, and any required post-processing. The output of an ML scenario is a trained model which can be used to generate inferences. An ML scenario can be provided as a content package to be deployed in an ML platform, as a multi-tenant ML service which runs as a single instance, as a single global instance, and as reusable ML Function-as-a-Service.

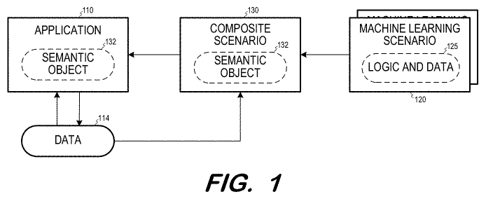

FIG. 1 is a block diagram of relationships between application 110 and multiple machine learning scenarios 120 according to some embodiments. Application 110 may comprise a software application written in any language and executing on any operating system in any one or more hardware devices. The hardware devices may be cloud-based (e.g., virtual machines) or on-premise.

Composite scenario 130 provides application 110 with an abstracted view of the 1 to n ML scenarios 120. Composite scenario 130 is an abstract entity which represents 1 to n ML scenarios 120 used by application 110 to acquire a composite inference. In this regard, composite scenario 130 encapsulates the individual inferences generated by each of 1 to n ML scenarios 120 into semantic object 132, which may be consumed by application 110.

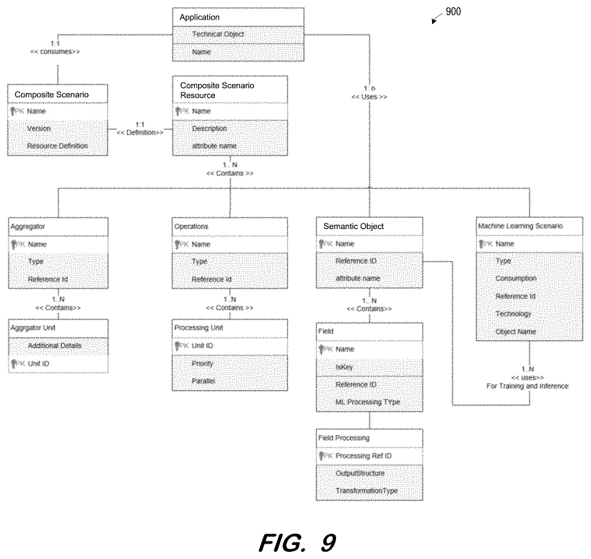

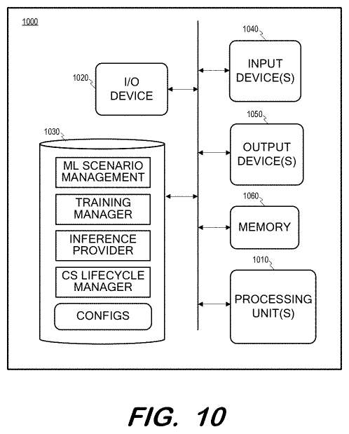

Composite scenario 130 includes a list of associated ML learning scenarios, a list of semantic objects used in the ML scenarios, inference result field mapping and aggregators, ML scenarios orchestration logic and orchestration variants, as well as additional attributes and functions, examples of which are described below with respect to FIG. 9. By virtue of composite scenario object 130, application 110 is not responsible for handling technology dependencies of the individual ML scenarios, and instead interacts with a consistent interface to request and acquire composite inferences. Any addition, change, and extension of ML scenarios is represented within composite scenario object 130 and, as a result, does not require code changes within application 110.

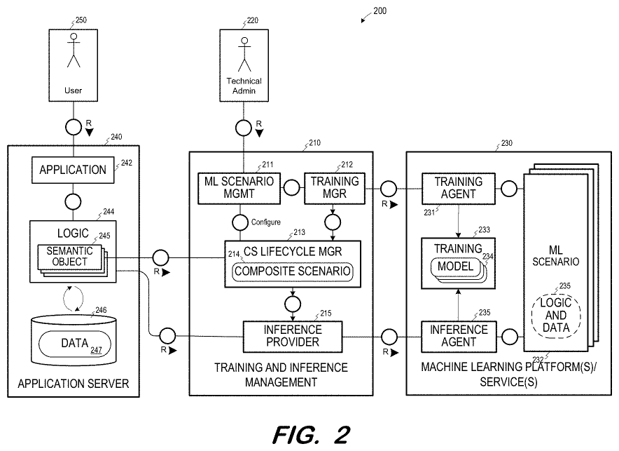

FIG. 2 is a block diagram of an architecture of system 200 which may utilize the relationships shown in FIG. 1 according to some embodiments. The illustrated elements of system 200 may be implemented using any suitable combination of computing hardware and/or software that is or becomes known. Such a combination may include implementations which apportion computing resources elastically according to demand, need, price, and/or any other metric. In some embodiments, two or more elements of system 200 are implemented by a single computing device. Two or more elements of system 200 may be co-located. One or more elements of system 200 may be implemented as a cloud service (e.g., Software-as-a-Service, Platform-as-a-Service).

Training and inference management component 210 may provide training, deployment, activation, monitoring, and connectivity configuration for composite ML scenarios consisting of one or more ML scenarios 232. Each ML scenario 232 includes corresponding logic (e.g., algorithms) and data (e.g., metadata defining input data) 235 as described above.

Two or more ML scenarios 232 and their corresponding training agent 231, training component 233 and inference agent 235 may be provided by different ML platforms and/or services. A single ML platform/service may provide one or more ML scenario 232, in which case the ML scenarios provided by the single ML platform/service may share training agent 231, training component 233 and inference agent 235.

Training and inference management component 210 includes ML scenario management component 211 which may be accessed by technical administrator 220 to manage ML scenarios and composite ML scenarios. ML scenario management component 211 lists the individual ML scenarios available in a system, as well as the available composite scenarios and their dependencies. Technical administrator 220 may operate ML scenario management component 211 to maintain the technical configurations, connectivity configurations, and security configuration for an ML scenario. ML scenario management component 211 uses training manager component 212 to sending a training dataset for a particular ML scenario to the ML platform/service which is configured to train the ML scenario.

Logic 244 of application 242 calls inference provider 215 of training and inference management component 210 to request an inference from a composite ML scenario. Inference provider 215 determines connection information for each ML scenario 232 of the composite ML scenario and uses the connection information to trigger an inference from each ML scenario 232. Inference provider 215 also provides a semantic object including the aggregated individual inference results to application 242. Each ML scenario 232 registers its semantic object in training and inference management component 210. Training and inference management component 210 therefore decouples application 242 from the specifics of each constituent ML scenario.

Composite scenario object 214 includes metadata describing a single composite ML scenario and the one or more ML scenarios included in the single composite scenario. Each of the one or more ML scenarios is described by a resource file associated with composite scenario object 214. Composite scenario lifecycle management component 213 may include more than one composite scenario object, each of which is associated with a respective composite ML scenario.

Composite scenario lifecycle management component 213 and composite scenario object 214 allow application logic 244 to use a same interface to all composite ML scenarios used by application 242. A developer of application 242 codes resource files for each ML scenario to be used in a composite ML scenario so as to support that interface and provides such resource files to composite scenario lifecycle management component 213.

According to some embodiments, composite scenario object 214 is in a markup language format and specifies the ML scenarios of the composite ML scenarios, operation sequence (e.g., any required sequence in which training of the ML scenarios of the composite ML scenario and/or the generation of inferences should occur), aggregations, allowed operations, relevant semantic objects. Application 242 registers composite scenario file 214 as a composite scenario object in training and inference management component 210. Composite scenario lifecycle management component 213 is an agent that interprets composite scenario object 214 and determines training and inference-related actions to perform. Technical administrator 220 may interact with composite scenario lifecycle management component 213 via ML scenario management component 211 to view mappings between applications and composite scenario files and to view the constituent ML scenarios.

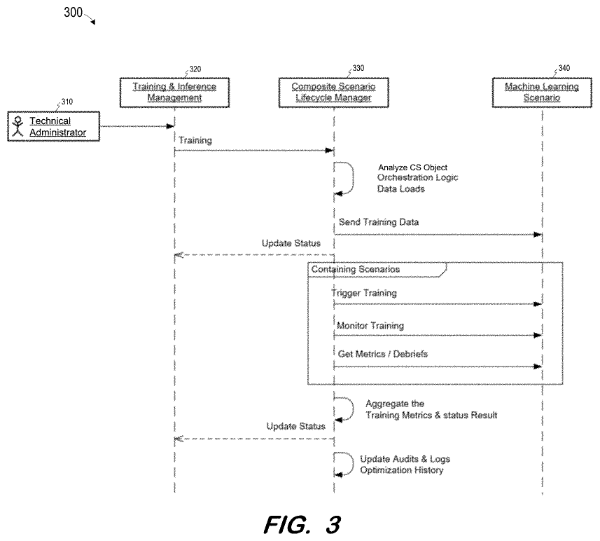

FIG. 3 shows sequence diagram 300 of training a composite machine learning scenario according to some embodiments. The components shown in diagram 300 may be implemented by similarly-named components described above with respect to FIG. 2, but embodiments are not limited thereto.

As shown, technical administrator 310 (e.g., a privileged user authorized to trigger training and inference calls) accesses training and inference management component 320 (e.g., via ML scenario management component 211) and identifies a composite scenario file associated with a given application (e.g., service order composite scenario file). Technical administrator 310 then manipulates a user interface control to issue an instruction to training and inference management component 320 to train the composite ML scenario.

In response to the instruction, composite scenario lifecycle manager 330 interprets the composite scenario file to determine the orchestration logic and the data load mechanisms to execute. In some embodiments, composite scenario lifecycle manager 330 also determines, based on a configuration file configurable by technical administrator 310, which of the ML scenarios in the composite ML scenario are to be trained. For example, technical administrator 310 may edit the configuration file to specify that only a certain three of five ML scenarios specified in the composite ML scenario are to be trained.

Composite scenario lifecycle manager 330 then sends training data (e.g., received from application server 240 for each machine learning scenario 340 of the composite ML scenario to the appropriate ML platform(s)/service(s). Sending this data may be optimized to account for, among other things, multiple ML scenarios using a same dataset and executing in a same ML platform/service.

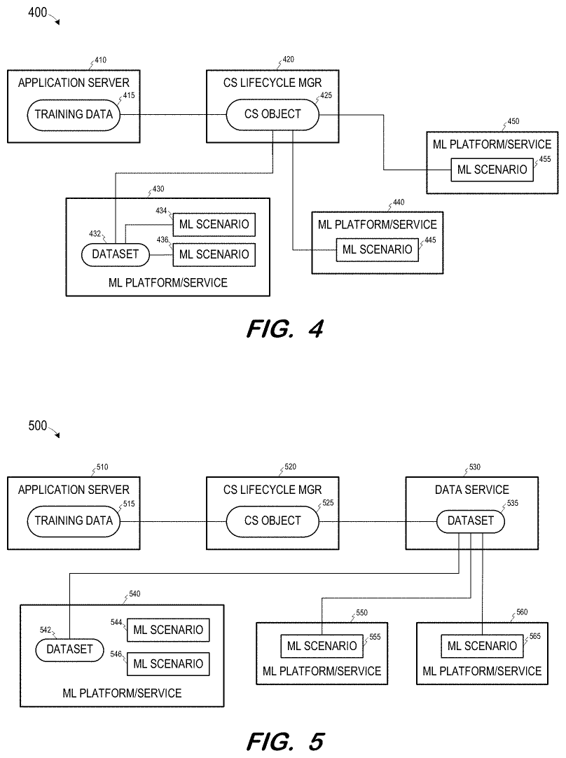

For example, multiple ML scenarios in a composite ML scenario may use the same dataset to perform different ML algorithms and pipelines in a same ML platform. FIG. 4 illustrates an example thereof, in which ML platform/service 430 includes two ML scenarios 434 and 436 associated with composite scenario object 425. Rather than push a corresponding dataset of training data 415 needed by ML scenarios 434 and 436 from application server 410 to each of ML scenarios 434 and 436, composite scenario lifecycle manager 330 ensures dataset 432 is sent only once and is referenced by each of ML scenarios 434 and 436 reference the pushed dataset. Such an arrangement reduces processing load on application server 410.

FIG. 5 illustrates another optimization of the sending of a training dataset to two or more ML scenarios specified in a composite scenario object. As shown, composite scenario lifecycle manager 520, based on the declarations of orchestration logic and ML scenarios supported mechanisms in the object 525, pushes dataset 535 of training data 515 to data service 530. Dataset 535 of data service 530 is referenced by each ML scenario 544, 546, 555 and 565 using appropriate connection configurations.

In further optimizations, the training dataset is tagged and locked such that all ML scenarios using a dataset with the same timeline and volume. Such an optimization may reduce data variance among the ML scenarios to improve consistency of resulting trained models.

After successfully sending the training data, and for each ML scenario individually, composite scenario lifecycle manager 330 triggers training, monitors training, and gets metrics/debriefs associated with the training. Composite scenario lifecycle manager 330 aggregates the training metrics and status results to generate a status of the overall composite ML scenario training. The results may include confidence and accuracy rates, and indications of successful and failed trainings. The status is then provided to training and inference management component 320 in an aggregated and unified way to provide an indication of whether the composite ML scenario is suitably trained.

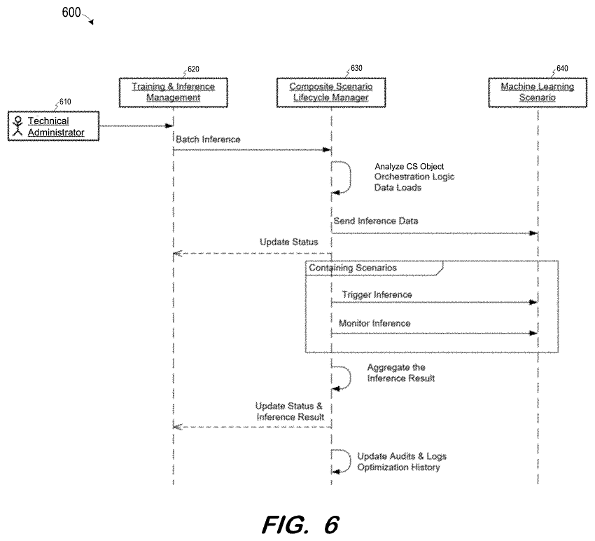

FIG. 6 illustrates sequence diagram 600 of a batch inference according to some embodiments. Technical administrator 610 accesses training and inference management component 630 and requests a batch of inferences from a particular composite ML scenario based on a batch of input data. Composite scenario lifecycle manager 630 first determines whether active trained models exist for each ML scenario of the composite scenario, and then executes the orchestration logic and data loads required to send the inference data (i.e., the model inputs) to the associated ML platforms(s)/service(s). The inference data may be pushed as described above with respect to FIGS. 4 and 5.

After all data is pushed, each ML scenario 640 is triggered to generate an inference result for each requested inference of the batch. Next, composite scenario lifecycle manager 630 aggregates all inference results associated with one request into a single semantic object, which may require stitching multiple results which have different structures and arrive via different APIs. Each semantic object (i.e., one per inference request of the batch) is then returned to training and inference management component 620.

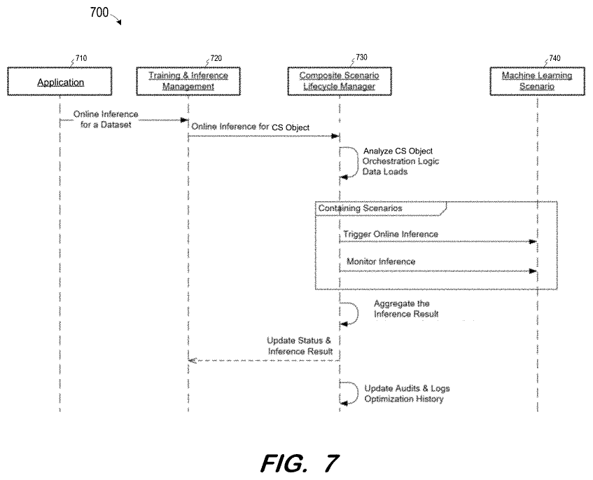

FIG. 7 illustrates sequence diagram 700 of an online inference request associated with a composite ML scenario. Such a request is generated by application 710 based on a particular dataset. Accordingly, the inference request of diagram 700 may be triggered by a user of application 710.

The request is passed to composite scenario lifecycle manager 730, which determines whether active trained models exist for each ML scenario of the composite scenario, and executes the orchestration logic and data loads required to send the dataset to the ML platforms(s)/service(s) associated with each ML scenario. Each ML scenario 740 is then triggered to generate an inference result and all inference results associated with the request are aggregated into a single semantic object. The semantic object is then returned to training and inference management component 720 and then to application 710.

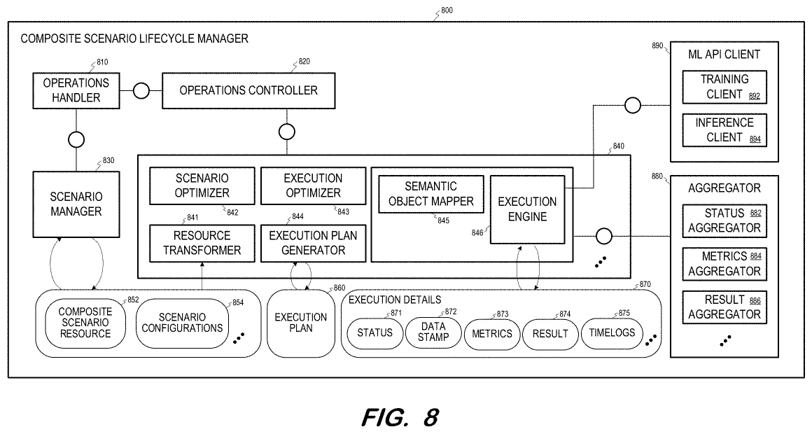

FIG. 8 is a block diagram of composite scenario lifecycle manager 800 according to some embodiments. Composite scenario lifecycle manager 800 is a reusable component and may be responsible for creation of a composite scenario object, handling of operations (e.g., training, activation, data push, customization, deployments) associated with a composite scenario object, technical configurations related to a composite scenario object, batch and online inference request processing for a composite scenario object, and work/system load management for a composite scenario object. Composite scenario lifecycle manager 800 includes multiple modules having specific responsibilities which to provide the above-described functionality to a technical administrator via training and inference management component.

Operations handler 810 provides access methods and interfaces for the external components to interact with composite scenario lifecycle manager 800. Operations handler 810 may implement role-based access policies to restrict the allowed operations. Operations handler 810 may divide incoming requests into resource management requests such as creation, update, deletion, and configurations, and resource operation requests such as training, deployment, and inference.

A composite scenario resource supports training, deployment, inference, and invalidation operations. Operations controller 820 acts as the operation facade to invoke respective modules to perform the intended ML operations. Operations controller 820 is responsible to execute the complete composite scenario flows.

Scenario manager 830 is capable of the creation, deletion, and update of persisted composite scenario resource files 852. Each composite scenario resource file 852 may be stored in association with a unique identifier and version and respective configuration maps. Scenario manager 830 also facilitates the storage of resource-specific configurations 854.

Resource transformer 841 transforms a composite scenario resource file 852 (e.g., stored as a YAML structure) into a composite scenario object. Resource transformer 841 validates the composite scenario resource declarations semantically. When an operation is triggered on a composite scenario resource file 852, resource transformer 841 converts a version of the composite scenario resource file 852 into a composite scenario object based on reflections. The composite scenario object will be used in runtime through the different modules of manager 800 as a reference. In case of failure or error in loading composite scenario resource files 852, resource transformer 841 aborts the operation.

A composite scenario resource file 852 contains information regarding ML scenarios, annotations, and operation-specific orchestration logic. Execution plan generator 844 generates an execution plan 860 for a provided composite scenario object and given ML operation, keeping various boundary conditions and system resource availability under consideration. The execution plan 860 converts the orchestration logic from the composite scenario resource file 852 into a task-based instruction. An execution plan 860 is generated for each operation request at a given point in time and is timestamped and stored as a YAML file. The execution plan model is state-based in that it contains the current state of the system resource, ML service, and platform.

An execution plan 860 is provided as an input to execution engine 846. Execution engine 846 is a singleton instance running in an uninterrupted mode and is responsible to run the operations of an execution plan 860. For example, a training operation requires high stability and an inference operation requires high availability and atomicity. Execution engine 846 handles each operation request as an atomic entity. Execution engine 846 logs execution details into execution details persistency 870.

Execution details 870 contains execution status 871 and time stamped data 872 of each task and event of an operation. On completion of a training operation, the training status 871, metrics 873, de-briefing data, and metadata of the training dataset are stored. On completion of an inference operation, the inference request data and result 874 are stored.

Semantic object mapper 845 reads an inference result 874 associated with a composite scenario object and populates the respective fields in the semantic object structure. The semantic object is a single structure to consume inferences of a composite structure. Any changes in the mapping of fields or extension of ML scenarios are handled by semantic object mapper 845.

Multiple ML scenarios of a composite scenario object may use the same data source/dataset to perform different ML algorithms and pipelines on a same platform. Scenario optimizer 842 and execution optimizer 843 coordinate sending of the dataset to the platform only once as described above with respect to FIGS. 4 and 5.

ML API client 890 invokes different operation and repository APIs from registered/supported ML platforms and services. ML API client 890 contains predefined adapters and API handlers supporting the ML platforms and services.

Since a composite scenario object contains multiple ML scenarios, the results, metrics, and status details of the training or inference generation of each ML scenario are aggregated to provide single consolidated view thereon. Aggregator 880 includes aggregators 882, 884 and 886 to aggregate status, metrics debriefs, and results so that each type of information may be presented to the requestor as a single entity.

FIG. 9 is an entity relationship diagram of a composite scenario object according to some embodiments. As shown, an application consumes a composite scenario which may include one or more machine learning scenarios. The machine learning scenarios may generate inferences to populate a semantic object which is in turn used by the application.

FIG. 10 is a block diagram of a hardware system providing training and inference management according to some embodiments. Hardware system 1000 may comprise a general-purpose computing apparatus and may execute program code to perform any of the functions described herein. Hardware system 1000 may be implemented by a distributed cloud-based server and may comprise an implementation of training and inference management system 210 in some embodiments. Hardware system 1000 may include other unshown elements according to some embodiments.

Hardware system 1000 includes processing unit(s) 1010 operatively coupled to I/O device 1020, data storage device 1030, one or more input devices 1040, one or more output devices 1050 and memory 1060. Communication device 1020 may facilitate communication with external devices, such as an external network, the cloud, or a data storage device. Input device(s) 1040 may comprise, for example, a keyboard, a keypad, a mouse or other pointing device, a microphone, knob or a switch, an infra-red (IR) port, a docking station, and/or a touch screen. Input device(s) 1040 may be used, for example, to enter information into hardware system 1000. Output device(s) 1050 may comprise, for example, a display (e.g., a display screen) a speaker, and/or a printer.

Data storage device 1030 may comprise any appropriate persistent storage device, including combinations of magnetic storage devices (e.g., magnetic tape, hard disk drives and flash memory), optical storage devices, Read Only Memory (ROM) devices, and RAM devices, while memory 1060 may comprise a RAM device.

Data storage device 1030 stores program code executed by processing unit(s) 1010 to cause server 1000 to implement any of the components and execute any one or more of the processes described herein. Embodiments are not limited to execution of these processes by a single computing device. Data storage device 1030 may also store data and other program code for providing additional functionality and/or which are necessary for operation of hardware system 1000, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code;
a processing unit to execute the processor-executable program code to cause the system to:
receive a request to train a composite machine learning scenario comprising a plurality of machine learning scenarios;
in response to the request, identify a training dataset associated with each of the plurality of machine learning scenarios and trigger training of each of the plurality of machine learning scenarios based on an associated training dataset to generate a plurality of trained machine learning models;
acquire metrics associated with each trained machine learning model;
aggregate the acquired metrics into training metrics associated with the composite machine learning scenario; and
return the training metrics associated with the composite machine learning scenario.

2. A system according to claim 1, wherein at least two of the plurality of machine learning scenarios are trained on different machine learning platforms.

3. A system according to claim 1, wherein at least two of the plurality of machine learning scenarios are trained on same platform and based on a same training dataset, and wherein the processing unit is to execute the processor-executable program code to cause the system to transmit the same training dataset to the same platform only once.

4. A system according to claim 1, the processing unit to execute the processor-executable program code to cause the system to:
receive a second request to train a second composite machine learning scenario comprising a second plurality of machine learning scenarios;
in response to the second request, identify a training dataset associated with each of the second plurality of machine learning scenarios and trigger training of each of the second plurality of machine learning scenarios based on an associated training dataset to generate a second plurality of trained machine learning models;
acquire second metrics associated with each of the second plurality of trained machine learning models;
aggregate the acquired second metrics into second training metrics associated with the second composite machine learning scenario; and
return the second training metrics associated with the second composite machine learning scenario,
wherein the request and the second request conform to a same interface.

5. A system according to claim 4, wherein at least one of the plurality of machine learning scenarios is identical to at least one of the second plurality of machine learning scenarios.

6. A system according to claim 4, the processing unit to execute the processor-executable program code to cause the system to:
receive a first request for an inference result generated by the composite machine learning scenario;
in response to the first request, acquire an inference result from each of the first plurality of trained machine learning models;
aggregate the acquired inference results from each of the first plurality of trained machine learning models into an inference result of the composite machine learning scenario;
return the inference result of the composite machine learning scenario;
receive a second request for an inference result generated by the second composite machine learning scenario;
in response to the second request, acquire an inference result from each of the second plurality of trained machine learning models;
aggregate the acquired inference results from each of the second plurality of trained machine learning models into an inference result of the second composite machine learning scenario; and
return the inference result of the second composite machine learning scenario.

7. A system according to claim 1, the processing unit to execute the processor-executable program code to cause the system to:
receive a first request for an inference result generated by the composite machine learning scenario;
in response to the first request, acquire an inference result from each of the first plurality of trained machine learning models;
aggregate the acquired inference results from each of the first plurality of trained machine learning models into an inference result of the composite machine learning scenario; and
return the inference result of the composite machine learning scenario.

8. A method comprising:
receiving a request to train a composite machine learning scenario comprising a plurality of machine learning scenarios;
in response to the request, identifying a training dataset associated with each of the plurality of machine learning scenarios and trigger training of each of the plurality of machine learning scenarios based on an associated training dataset to generate a plurality of trained machine learning models;
acquiring metrics associated with each trained machine learning model;
aggregating the acquired metrics into training metrics associated with the composite machine learning scenario; and
returning the training metrics associated with the composite machine learning scenario.

9. A method according to claim 8, wherein at least two of the plurality of machine learning scenarios are trained on different machine learning platforms.

10. A method according to claim 8, wherein at least two of the plurality of machine learning scenarios are trained on same platform and based on a same training dataset, and further comprising transmitting the same training dataset to the same platform only once.

11. A method according to claim 8, further comprising:
receiving a second request to train a second composite machine learning scenario comprising a second plurality of machine learning scenarios;
in response to the second request, identifying a training dataset associated with each of the second plurality of machine learning scenarios and trigger training of each of the second plurality of machine learning scenarios based on an associated training dataset to generate a second plurality of trained machine learning models;
acquiring second metrics associated with each of the second plurality of trained machine learning models;
aggregating the acquired second metrics into second training metrics associated with the second composite machine learning scenario; and
returning the second training metrics associated with the second composite machine learning scenario,
wherein the request and the second request conform to a same interface.

12. A method according to claim 11, wherein at least one of the plurality of machine learning scenarios is identical to at least one of the second plurality of machine learning scenarios.

13. A method according to claim 11, further comprising:
receiving a first request for an inference result generated by the composite machine learning scenario;
in response to the first request, acquiring an inference result from each of the first plurality of trained machine learning models;
aggregating the acquired inference results from each of the first plurality of trained machine learning models into an inference result of the composite machine learning scenario;
returning the inference result of the composite machine learning scenario;
receiving a second request for an inference result generated by the second composite machine learning scenario;
in response to the second request, acquiring an inference result from each of the second plurality of trained machine learning models;
aggregating the acquired inference results from each of the second plurality of trained machine learning models into an inference result of the second composite machine learning scenario; and
returning the inference result of the second composite machine learning scenario.

14. A method according to claim 8, further comprising:
receiving a first request for an inference result generated by the composite machine learning scenario;
in response to the first request, acquiring an inference result from each of the first plurality of trained machine learning models;
aggregating the acquired inference results from each of the first plurality of trained machine learning models into an inference result of the composite machine learning scenario; and
returning the inference result of the composite machine learning scenario.

15. A non-transitory medium storing processor-executable program code executable by a processing unit of a computing system to cause the computing system to:
receive a request to train a composite machine learning scenario comprising a plurality of machine learning scenarios;
in response to the request, identify a training dataset associated with each of the plurality of machine learning scenarios and trigger training of each of the plurality of machine learning scenarios based on an associated training dataset to generate a plurality of trained machine learning models;
acquire metrics associated with each trained machine learning model;
aggregate the acquired metrics into training metrics associated with the composite machine learning scenario; and
return the training metrics associated with the composite machine learning scenario.

16. A medium according to claim 15, wherein at least two of the plurality of machine learning scenarios are trained on different machine learning platforms.

17. A medium according to claim 15, wherein at least two of the plurality of machine learning scenarios are trained on same platform and based on a same training dataset, and wherein the processor-executable program code is executable by a processing unit of a computing system to cause the computing system to transmit the same training dataset to the same platform only once.

18. A medium according to claim 15, the processor-executable program code executable by a processing unit of a computing system to cause the computing system to:
receive a second request to train a second composite machine learning scenario comprising a second plurality of machine learning scenarios;
in response to the second request, identify a training dataset associated with each of the second plurality of machine learning scenarios and trigger training of each of the second plurality of machine learning scenarios based on an associated training dataset to generate a second plurality of trained machine learning models;
acquire second metrics associated with each of the second plurality of trained machine learning models;
aggregate the acquired second metrics into second training metrics associated with the second composite machine learning scenario; and
return the second training metrics associated with the second composite machine learning scenario,
wherein the request and the second request conform to a same interface.

19. A medium according to claim 18, wherein at least one of the plurality of machine learning scenarios is identical to at least one of the second plurality of machine learning scenarios.

20. A medium according to claim 15, the processor-executable program code executable by a processing unit of a computing system to cause the computing system to:
receive a first request for an inference result generated by the composite machine learning scenario;
in response to the first request, acquire an inference result from each of the first plurality of trained machine learning models;
aggregate the acquired inference results from each of the first plurality of trained machine learning models into an inference result of the composite machine learning scenario; and
return the inference result of the composite machine learning scenario.
